(19) United States
(12) Patent Application Publication
(10) Pub. No.: US 2022/0221304 A1
(43) Pub. Date: Jul. 14, 2022

(54) METHOD FOR CREATING A SURROUNDINGS MAP FOR USE IN THE AUTONOMOUS NAVIGATION OF A MOBILE ROBOT

(71) Applicant: Robert Bosch GmbH, Stuttgart (DE)

(72) Inventors: Georg Stellmann, Ludwigsburg (DE); Sebastian Scherer, Tuebingen (DE)

(21) Appl. No.: 17/595,787

(22) PCT Filed: May 18, 2020
(86) PCT No.: PCT/EP2020/063784

§ 371 Date: Nov. 24, 2021

(30) Foreign Application Priority Data
May 29, 2019 (DE) 10 2019 207 870.2

(51) Int. Cl. G01C 21/00; G05D 1/02; G06Q 10/08

(52) U.S. Cl. CPC G01C 21/3841; G05D 2201/0216; G06Q 10/083; G05D 1/0274

(57) ABSTRACT

A method for creating a surroundings map for use in the autonomous navigation of a mobile robot in a map-based localization system in a logistics environment. Mobile objects of a merchandise management system having a known position are incorporated into the process of creating the surroundings map.

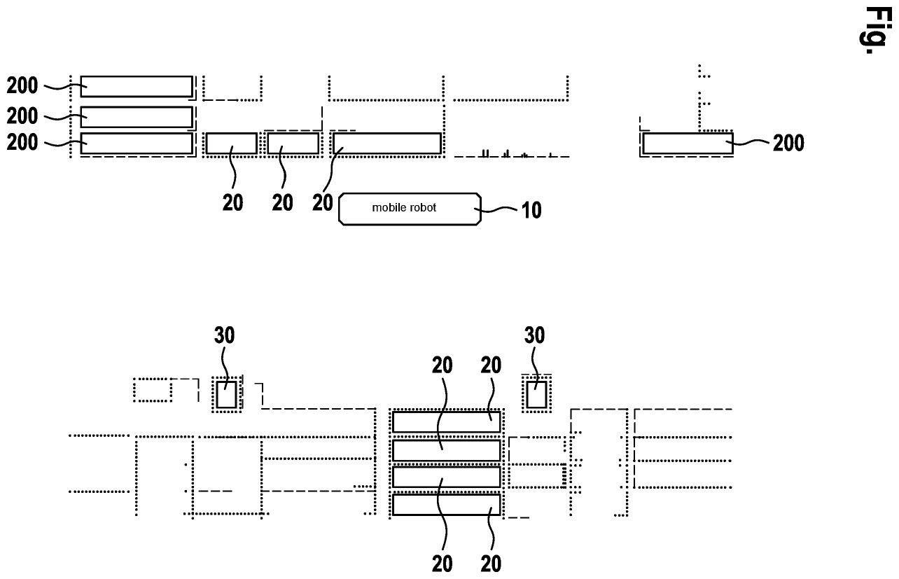

### FIELD

The present invention relates to a method for creating a surroundings map for use in the autonomous navigation of a mobile robot in a map-based localization system in a logistics environment. The present invention further relates to a computer program for carrying out a method of this type, a machine-readable memory medium, on which a computer program of this type is stored, as well as an electronic control unit for carrying out the method.

### BACKGROUND INFORMATION

It is presently standard practice in logistics centers for automatically guided vehicles to carry out the transport of goods in an automated manner. A navigation of the robotic vehicles takes place in structured surroundings of this type, for example based on markings on the floor.

For example, the German Patent Application DE 10 2014 100 658 A1 describes a stacker crane, which may be used in port facilities. Containers may be handled with the aid of this stacker crane, a horizontal cross member movable in the direction of travel is provided with a crane trolley, which is movable along and transversely to the direction of crane travel, includes liftable and lowerable load handling attachment for the containers.

A variant of the so-called SLAM algorithm (Simultaneous Localization and Mapping) is often used as the basis for a robot navigation. The robot creates a map of its surroundings and simultaneously localizes itself within this surroundings map. Algorithms are used for this process, which determine the position of the robot relative to its surroundings. A surroundings representation, i.e., a map, may be created for this purpose with the aid of an on-board sensor system of the mobile robot. The map encompasses the physical properties of the surroundings detectable with the aid of the sensors, for example laser scanners (LIDAR) or cameras. Depending on the sensors and methods used, the localization map may contain a combination of raw measured points, prominent points (features) or semantic objects (high-level features). In addition to the simultaneous localization and mapping, it is also possible for the mapping and the localization to be carried out in separate steps, possibly also with the aid of different vehicles or mobile robots.

### SUMMARY

An example embodiment of the present invention provides a method for creating a surroundings map for use in the autonomous navigation of a mobile robot in a map-based localization system in a logistics environment, mobile objects of a merchandise management system having a known position being incorporated into the process of creating the surroundings map. With the aid of this method, the localization accuracy and the robustness of map-based localization systems, for example in a port scenario, may be improved, by means of which the navigation quality of a corresponding robot, in particular a transport robot, for example a drivable crane or another vehicle, may also be indirectly improved. A mobile robot may furthermore be understood to be a flight-capable and/or autonomously acting robot, for example a drone, in particular a multicopter. The flight-capable robot may further be designed as an air taxi for transporting persons or passengers.

The method according to the present invention thus provides a significant improvement in the localization and navigation in variable surroundings. The navigation of autonomous transport robots in the logistics setting, for example a port facility, is conventionally difficult, since containers in port facilities are frequently moved, and the creation of a permanent map based on a surroundings representation is thus made more difficult. The provided method solves this problem, in that the mobile objects, whose position is stored in a merchandise management system and is thus known, are incorporated into the creation of the surroundings map. Existing information from the merchandise management system with regard to the position of mobile objects of the merchandise management system, i.e., for example, containers, pallets or other prominent objects, is used and incorporated into the process of creating a surroundings map within the scope of a localization system. With the aid of the information from the merchandise management system, it may thus be detected, for example, whether a certain object is a mobile object. Changing positions of mobile objects may furthermore be taken into account directly in the surroundings map.

A merchandise management system in this context is understood to be a system which depicts the flow of goods within the business process of a company. The goods logistics of the merchandise management system used to organize the warehouse management is important for the present invention. Information about the positions of objects of the merchandise management system to be entered into or removed from stock is contained in the warehouse management system. Information about the position of, for example, containers or pallets or other mobile objects of the merchandise management system may thus be called up from the merchandise management system. For example, a port administration generally works with a merchandise management system, in which the locations of the containers handled in the port facility are detected in real time. According to the method according to the present invention, this information flows into the creation of a surroundings map, which is used for the autonomous navigation of a mobile robot.

The method may thus be particularly advantageously used, in particular, for automated guided vehicles (AGVs), which transport, for example, containers in ports. Moreover, the method is also suitable for other automated vehicles or other mobile robots, which are used in a logistics environment.

The logistics environment is preferably a port facility. A port facility generally represents a particularly dynamic surroundings, since numerous containers are frequently moved and relocated or handled in the port. For example, precise working cranes are used, which receive the containers or other units and transport and deposit them at other predetermined positions. This relocation of containers is generally controlled via a merchandise management system. Cranes of this type or other mobile transport robots work, for example, on the basis of a laser localization and are also particularly advantageously suitable for the use of the provided method.

It is possible that the surroundings map, which is used for the navigation of a mobile robot, is created exclusively on the basis of position information relating to the mobile objects from the merchandise management system. This map may be continuously compared with the information from the merchandise management system, so that changing positions of, for example, containers, may be transferred to the surroundings map within a short period of time or in real time. A mobile robot may localize itself and navigate precisely in a dynamic map of this type.

In one particularly preferred embodiment of the method of the present invention, the mapping of the mobile objects may additionally take place based on sensor data of the mobile robot, the objects detected by the mobile robot being compared with the known position data from the merchandise management system to thereby create a precise surroundings map. This process preferably takes place within the scope of a simultaneous localization and mapping of the mobile robot, in particular within the scope of a SLAM algorithm.

In one advantageous embodiment of the method of the present invention, a dynamic semantic map is generated during the creation of the surroundings map, based on the known positions of the mobile objects of the merchandise management system. It is not absolutely necessary that the mobile objects be mapped with the aid of the sensor system of a mobile robot. Instead, it is also possible that this dynamic semantic map is generated exclusively on the basis of the information from the merchandise management system. The special advantage of this is that the varying positions of containers or other mobile objects known from the merchandise management system may be represented within a short period of time or in real time in the dynamic semantic map, so that an up-to-date surroundings map is always present, which may be used for a precise localization and navigation of a mobile robot.

In a further specific embodiment of the method of the present invention, it may be alternatively or additionally provided that a mapping of static objects as well as a mapping of the mobile objects of the merchandise management system take place during the creation of the surroundings map. In this embodiment, for example, a further level, which represents the dynamic objects of the merchandise management system or their positions, may be added to a classically generated localization map, which is made up, for example, of a static map on the basis of a point cloud. Mobile robots or other automated vehicles may thus use a combination of a static surroundings map and a dynamic surroundings map for their localization and navigation. The resulting surroundings map may, to a certain extent, have two levels. The first level represents the static surroundings map. A further level represents the mobile objects of the merchandise management system, this further level being dynamically adaptable.

In a further preferred embodiment of the method of the present invention, a classically generated localization map, which is based in the conventional manner on static objects, may be cleaned up in such a way that, when creating the surroundings map, the mobile objects of the merchandise management system are filtered out during a mapping. This is based on the fact that the sensors of a mobile robot conventionally are unable to distinguish between static objects and mobile objects. During the mapping by a mobile robot or by a mapping vehicle, it is therefore usually not possible in conventional methods to prevent mobile objects from being detected and then added to the static map. When the particular mobile object changes position, this results in problems for the navigation of a mobile robot. The provided method solves this problem in that these dynamic objects are filtered out, for example already during a mapping run, by incorporating information about the known positions of mobile objects of the merchandise management system, and are thereby not entered into the surroundings map. In this specific embodiment of the method, the surroundings map created according to the provided method omits the mobile objects for creating the surroundings map to a certain extent, so that the navigation of a mobile robot is based exclusively on the invariable positions of static objects in the surroundings.

It may be advantageous for creating the surroundings map if the positions of the mobile objects are projected in a reference coordinate system. As a result, it is possible to also convert the mobile objects having dynamic positions into a map-like representation, which may be used to localize a mobile robot with the aid of classic methods, for example a scan matching.

The present invention further includes a computer program, which is configured to carry out the described steps of the provided method. In accordance with an example embodiment of the present invention, a computer program of this type may be used, in particular, within the scope of a map-based localization system in a logistics environment, in particular in a port facility. A computer program of this type may be configured, for example, as an additional module of a merchandise management system to further improve the autonomous navigation of a mobile robot, for example an autonomous transport vehicle or a movable crane. The present invention further includes a machine-readable memory medium, on which a computer program of this type is stored, as well as an electronic control unit, which is configured to carry out the steps of the method according to the present invention.

The aforementioned advantages apply correspondingly, in particular, to a mobile robot for creating a surroundings map for use in autonomous navigation. The mobile robot may furthermore be designed as a flight-capable and/or autonomously acting robot, for example a drone, in particular a multicopter. The flight-capable robot may further be designed as an air taxi for transporting persons or passengers.

Further features and advantages of the present invention are derived from the following description of exemplary embodiments of the present invention in connection with the FIGURE. The individual features may be implemented individually or in combination with each other.

### BRIEF DESCRIPTION OF THE DRAWING

The FIGURE shows an up-to-date laser scan of an autonomously navigating mobile robot within the dynamic surroundings of a port facility.

### DETAILED DESCRIPTION OF EXAMPLE EMBODIMENTS

The FIGURE illustrates the problem of localizing an autonomously navigating mobile robot 10 in a port facility. The port facility is characterized by changing surroundings, which is caused by a continuous repositioning of containers 20, 200. The scene illustrated schematically in the FIGURE is based, in principle, on a conventional method, according to which mobile robot 10 is localized in the port surroundings with the aid of a static map, for example in the form of a point cloud (points in an original LIDAR map), which is represented by dotted lines. Mobile robot 10 is equipped with, for example, laser scanners, and generates a laser scan (instantaneously measured LIDAR points), represented here by dashed lines. Alternatively or additionally, however, other sensors, for example cameras, may be used at mobile robot 10 for the localization. The localization and the navigation based thereon take place with the aid of a so-called scan matching. The instantaneous position and orientation of mobile robot 10 is estimated in such a way that the instantaneous laser scan (dashed lines) matches the point cloud of the static map (dotted lines) as best as possible. The static map may be made up, for example, of point features, (e.g., SIFT features—Scale Invariant Feature Transform), which occur in the instantaneous camera image as correspondences. The estimated camera position and orientation is then estimated in such a way that the back projection error of all correspondences is minimized. The difference between the expected position of the point feature in the image and the position which was actually detected is therefore kept as small as possible.

A few containers 20, 200, which are located in a different place in the static and thus outdated map than in the instantaneous laser scan are detectable in the instantaneous laser scan (dashed) and in the static map (dotted). Containers 20 are containers which were present in the original (static) map but are no longer located there. Containers 200 are containers which are currently present but were not present in the original (static) map. This results in problems in the localization and navigation of mobile robot 10. These problems may be solved by the provided method, in that the objects detected in the laser scan of mobile robot 10 are compared with the employed merchandise management system of the logistics environment. The merchandise management system is thus connected to the localization or mapping system. The surroundings map may thus be updated in such a way that the changes in position of containers 20, 200 or other mobile objects, whose position is known, may be tracked and corrected. The surroundings map is thus, in principle, always up to data, and no problems occur in the localization and navigation of mobile robot 10.

It may be provided, for example, that mobile objects 20, 200, i.e., for example the containers of the merchandise management system, are projected into a reference coordinate system and thus converted into a map-like representation. This map-like representation may be created, for example, exclusively on the basis of information from the merchandise management system. This dynamic semantic map, which contains the instantaneous positions of the objects of the merchandise management system, may be used for the localization and navigation of mobile robot 10 in a conventional manner, for example with the aid of scan matching and the evaluation of point features.

A map of this type may be further combined with a classic static localization map, static objects 30 of the surroundings being used for creating the map. Depending on the method, points or point features of a static map as well as a dynamic map may be accumulated for this purpose. In particular, the positions of mobile objects 20, 200, i.e., for example, the containers, may be taken into account in such a way that their position in the static map is corrected in that instantaneous position 200 superimposes outdated position 20.

The method in accordance with the present invention may furthermore be used with regard to a cleaning up of a classic localization map of dynamic or mobile objects 20, 200 of the merchandise management system. To filter out mobile objects 20, 200 during the data processing for mapping, all measurements, i.e., for example, points of a laser scan or other visual point features, are checked to see whether they may or may not be assigned to a mobile object. If the detected points or point features are mobile objects 20, 200, the objects used for setting up the static localization map may be discarded or filtered out. For example, a static map of containers 20, 200 may be cleaned up, so that only static objects 30 are used for a localization and navigation of mobile robot 10.

1-14. (canceled)

15. A method for creating a surroundings map for use in autonomous navigation of a mobile robot in a map-based localization system in a logistics environment, the method comprising:
creating the surroundings map; and
incorporating mobile objects of a merchandise management system having known positions into the creating of the surroundings map.

16. The method as recited in claim 15, wherein existing information from the merchandise management system with regard to the position of the mobile objects of the merchandise management system are used and incorporated into the creating the surroundings map within the scope of the localization system.

17. The method as recited in claim 16, wherein the mobile objects include containers and/or pallets and/or prominent objects,

18. The method as recited in claim 15, wherein information about the positions of the mobile objects of the merchandise management system are called up from the merchandise management system, and the information flows into the creating of the surroundings map, which is used for the autonomous navigation of the mobile robot.

19. The method as recited in claim 18, wherein the mobile objects include containers and/or pallets.

20. The method as recited in claim 15, wherein the logistics environment is a port facility.

21. The method as recited in claim 15, wherein the creating of the surroundings map takes place based on sensor data of the mobile robot.

22. The method as recited in claim 15, wherein the creating of the surroundings map takes place within the scope of a simultaneous localization and mapping of the mobile robot.

23. The method as recited in claim 15, wherein a dynamic semantic map is generated during the creating of the surroundings map, based on the known positions of the mobile objects of the merchandise management system.

24. The method as recited in claim 15, wherein a mapping of static objects during the creating of the surroundings map is supplemented by a mapping of the mobile objects of the merchandise management system.

25. The method as recited in claim 15, wherein, during the creating of the surroundings map, the mobile objects of the merchandise management system are filtered out during a mapping.

26. The method as recited in claim 15, wherein the positions of the mobile objects are projected into a reference coordinate system.

27. A non-transitory machine-readable memory medium on which is stored a computer program for creating a surroundings map for use in autonomous navigation of a mobile robot in a map-based localization system in a logistics environment, the computer program, when executed by a computer, causing the computer to perform the following:
creating the surroundings map; and
incorporating mobile objects of a merchandise management system having known positions into the creating of the surroundings map.

28. An electronic control unit configured to create a surroundings map for use in autonomous navigation of a mobile robot in a map-based localization system in a logistics environment, the electronic control unit configured to:
create the surroundings map; and
incorporate mobile objects of a merchandise management system having known positions into the creating of the surroundings map.

29. A mobile robot, comprising:
an electronic control unit configured to create a surroundings map for use in autonomous navigation of a mobile robot in a map-based localization system in a logistics environment, the electronic control unit configured to:
create the surroundings map, and
incorporate mobile objects of a merchandise management system having known positions into the creating of the surroundings map.
